(19) United States
(12) Patent Application Publication
(10) Pub. No.: US 2025/0299602 A1
(43) Pub. Date: Sep. 25, 2025

(54) EQUINE NASOGASTRIC TUBE MODEL AND RELATED METHODS

(71) Applicant: Texas Tech University System, Lubbock, TX (US)

(72) Inventors: Luis Angel Morales Luna, Canyon, TX (US); Guy Gilbert, Amarillo, TX (US)

(21) Appl. No.: 19/086,007

(22) Filed: Mar. 20, 2025

Related U.S. Application Data
(60) Provisional application No. 63/567,588, filed on Mar. 20, 2024.

(51) Int. Cl. G09B 23/36; A61D 99/00; B33Y 80/00

(52) U.S. Cl. CPC G09B 23/36; B33Y 80/00; A61D 99/00

(57) ABSTRACT

Systems and associated method of fabrication of anatomically accurate animal training models can comprise fabricating at least one inverse anatomical feature representative of an anatomical feature in an animal's head, forming a mold of the animal's head, connecting the at least one inverse anatomical feature in the mold of the animal's head, filling the mold of the animal's head with a filling material, and removing the cast head from the mold.

### CROSS REFERENCE TO RELATED PATENT APPLICATIONS

This application claims the priority and benefit under 35 U.S.C. § 119 (e) of U.S. Provisional Patent Application Ser. No. 63/567,588 filed Mar. 20, 2024, entitled “EQUINE NASO-GASTRIC TUBE MODEL AND RELATED METHODS.” U.S. Provisional Patent Application Ser. No. 63/567,588 is herein incorporated by reference in its entirety.

### TECHNICAL FIELD

Embodiments are generally related to the field of medicine. Embodiments are further related to veterinary medicine. Embodiments are also related to education. Embodiments are also related to veterinary education. Embodiments are further related to equine veterinary training.

### BACKGROUND

Equine veterinary practice is a highly specialized field of veterinary medicine, yet horse-related activities are increasingly popular. As of 2012, almost a third of U.S. households participated in the equine world in some fashion. However, the share of veterinarians practicing as equine specialists is somewhere between 3% and 6% of the total pool of veterinarians. Practicing as an equine veterinarian is very difficult and requires specialized training, but because equine specialists represent a relatively small proportion of veterinarians, training solutions and equipment for equine-based medicine is limited.

In addition, the use of live animals with inexperienced students to teach basic techniques necessary to be an equine veterinarian can be unsafe for the animal and the student. As a result, students usually learn techniques by attending lectures in class and then watching live demonstrations or videos which show how to perform specialized procedures.

An example of one such technique, which is very difficult to teach, is a nasogastric intubation. Nasogastric intubation is a life-saving procedure routinely performed in cases of equine colic, a disease that affects ˜4-10% of horses at least once in their lifetime. The procedure is typically performed by a skilled veterinarian by blindly passing/directing a nasogastric tube through the nose and throat of the horse into the stomach. This requires careful navigation to avoid causing harm to the sensitive nasal structures along the way.

While lecture and demonstrations can be helpful, there is no substitute for practicing nasogastric intubation. Typical curriculum therefore generally involves a live horse, despite the potential risk to the horse as well as the student. Each student is usually given two chances to pass the nasogastric tube on the live horse. If either of their attempts causes bleeding the student stops, and loses the chance to perform a nasogastric intubation. Complications associated with incorrect nasogastric intubation of a live animal can include trauma to the nasal mucosa and turbinates, resulting in epistaxis, pharyngitis/laryngitis resulting from trauma following attempts to have the horse swallow the nasogastric tube or from long-term placement, aspiration pneumonia from inadvertently administering liquid through a tube passed into the trachea instead of the esophagus, and even death.

Thus, current curriculum which limits practice on live animals is necessary to protect the wellbeing of the animals, but may also result in diminished student confidence. In some cases, this may also steer students away from a career in equine veterinary medicine where they are desperately needed.

Given the critical need for skilled equine practitioners, as well as the need to protect the safety of live horses which would otherwise serve as subjects of veterinary training, there is a need for improved systems and methods for helping students develop skills relating to equine veterinary techniques as disclosed herein.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide medical training devices.

It is another aspect of the disclosed embodiments to provide methods and systems for equine medical training.

It is another aspect of the disclosed embodiments to provide methods and systems for veterinary training devices.

It is another aspect of the disclosed embodiments to provide anatomically accurate models of animals, particularly models with fidelity to anatomical features in the animal's head.

It is another aspect of the disclosed embodiments, to provide methods for fabricating anatomically accurate animal models for educational training.

It is another aspect of the disclosed embodiments to provide methods, systems, and apparatuses for simulating equine anatomy, in order to allow students to safely practice equine veterinary procedures without risking injury to live animals or the students.

It will be appreciated that the methods and systems can be achieved according to the embodiments disclosed herein. In an embodiment, a method for fabricating a training model comprises fabricating at least one inverse anatomical feature representative of an anatomical feature in an animal's head, forming a mold of the animal's head, connecting the at least one inverse anatomical feature in the mold of the animal's head, filling the mold of the animal's head with a filling material, and removing the cast head from the mold. In an embodiment, the method for fabricating a training model further comprises acquiring a digital model of the animal's head. In an embodiment, fabricating the inverse anatomical features representative of anatomical features in an animal's head further comprises 3D printing the inverse anatomical features. In an embodiment, the method for fabricating a training model further comprises coating the inverse anatomical features with an applique to smooth the inverse anatomical features. In an embodiment, the anatomical feature comprises at least one of: a nare, a nasopharynx, an esophagus, a trachea, and a guttural pouch. In an embodiment, the method for fabricating a training model further comprises fabricating a viewing window to the nasopharynx. In an embodiment, the method for fabricating a training model further comprises adhering the at least one anatomical features to one another. In an embodiment, the filling material comprises silicone. In an embodiment, the method for fabricating a training model further comprises curing the silicone. In an embodiment, the animal's head comprises a horse's head.

In an embodiment, a method for fabricating a training system comprises fabricating a mold comprising a shell of an animal's head, inserting foam in the mold, forming at least one anatomical feature in the foam, applying at least one coat of material over the foam, and affixing the mold to a display system. In an embodiment, forming the at least one anatomical feature in the foam comprises cutting away foam in anatomically accurate shapes. In an embodiment, the coat of material comprises silicone. In an embodiment, the method for fabricating a training model further comprises curing the silicone. In an embodiment, the at least one anatomical feature comprises at least one of a mouth and nose, a nasal cavity, an epiglottis, an esophagus, and a trachea. In an embodiment, the display system comprises a transparent sheet. In an embodiment, the animal's head comprises a horse's head.

In an embodiment, a head model comprises a cast silicone structure in a shape of an animal's head, at least one anatomical feature formed in the case silicone structure, and at least one view port configured to provide visual and/or physical access to the at least one anatomical feature formed in the base silicone structure. In an embodiment, the at least one anatomical feature comprises at least one of a nare, a nostril, a nasopharynx, an esophagus, a trachea, a guttural pouch, a nasal cavity, and/or an epiglottis. In an embodiment, the animal's head comprises a horse's head.

### BRIEF DESCRIPTION OF THE FIGURES

The accompanying figures, in which like reference numerals refer to identical or functionally similar elements throughout the separate views and which are incorporated in and form a part of the specification, further illustrate the embodiments and, together with the detailed description, serve to explain the embodiments disclosed herein.

FIG. 1 depicts a training system, in accordance with the disclosed embodiments;

FIG. 2A depicts steps associated with a method for fabricating a training system, in accordance with the disclosed embodiments;

FIG. 2B depicts a mold associated with a method for fabricating a training system, in accordance with the disclosed embodiments;

FIG. 2C depicts a mold filled with foam associated with a method for fabricating a training system, in accordance with the disclosed embodiments;

FIG. 2D depicts internal anatomical features formed in foam in a mold associated with a method for fabricating a training system, in accordance with the disclosed embodiments;

FIG. 2E depicts a coating applied to foam in a mold associated with a method for fabricating a training system, in accordance with the disclosed embodiments;

FIG. 2F depicts a simulated trachea attached to a mold associated with a method for fabricating a training system, in accordance with the disclosed embodiments;

FIG. 3A depicts a training model, in accordance with the disclosed embodiments;

FIG. 3B depicts a model base structure of a training model, in accordance with the disclosed embodiments;

FIG. 3C depicts anatomical features of a training model, in accordance with the disclosed embodiments;

FIG. 3D depicts aspects of a neck model associated with a training model, in accordance with the disclosed embodiments;

FIG. 3E depicts aspects of a neck model associated with a training model, in accordance with the disclosed embodiments;

FIG. 3F depicts aspects of a body model associated with a training model, in accordance with the disclosed embodiments;

FIG. 3G depicts aspects of a simulated stomach associated with a training model, in accordance with the disclosed embodiments;

FIG. 3H depicts additional aspects of a simulated stomach associated with a training model, in accordance with the disclosed embodiments;

FIG. 4A depicts steps associated with a method for fabricating a training model, in accordance with the disclosed embodiments;

FIG. 4B depicts an exemplary inverse mold of an anatomical feature associated with a method for fabricating a training model, in accordance with the disclosed embodiments;

FIG. 4C depicts an exemplary post-processed inverse mold of an anatomical feature associated with a method for fabricating a training model, in accordance with the disclosed embodiments;

FIG. 4D depicts a head mold associated with a method for fabricating a training model, in accordance with the disclosed embodiments; and

FIG. 4E depicts an exemplary cast head model associated with a method for fabricating a training model, in accordance with the disclosed embodiments.

### DETAILED DESCRIPTION

Embodiments and aspects of the disclosed technology are presented herein. The particular embodiments and configurations discussed in the following non-limiting examples can be varied, and are provided to illustrate one or more embodiments, and are not intended to limit the scope thereof.

Reference to the accompanying drawings, in which illustrative embodiments are shown are provided herein. The embodiments disclosed can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope and concept of the invention as defined by the appended claims.

Embodiments disclosed herein are generally related to methods and systems for realistic simulation models of animals, such as horses, for use as anatomically accurate training aids. Embodiments may generally comprise model head and neck regions of an animal with anatomically correct nasal and gastric channels. These structures allow students to practice Nasogastric intubation, which involves the insertion of a nasogastric tube for intubation. Embodiments may also include additional anatomical features such as a guttural pouch, which can be used in training related to upper airway disease management. The models disclosed herein can be used to help students learn proper techniques for using medical equipment such as endoscopes. In certain embodiments, the disclosed model can include additional anatomical sections in an animal. For example, embodiments can include a normal anatomic stomach from a horse configured to mimic different gastric diseases (e.g. gastric ulcers, gastric impactions, etc.) to allow students to practice proper use of a nasogastric tube for reflux collection or to perform a gastroscopy. In other embodiments, other simulated anatomical features can also, or alternatively, be included.

Embodiments disclosed herein include anatomical functional models and methods of manufacturing the same, which offer distinct advantages over present equine veterinary training. The disclosed models are anatomically accurate, so proper technique is required to successfully complete a procedure. Students can practice proper technique and experience common failures as many times as needed, without jeopardizing the health and safety of a live animal. For example, certain embodiments disclosed herein include a structure that can replicate the failure to pass a nasogastric tube through the esophagus (positive result) or going into the airways (negative result) without putting a live animal at risk of death due to iatrogenic aspiration of water/mineral oil. By using a model to train students, complications associated with passing a nasogastric tube or endoscope in a live animal can be avoided.

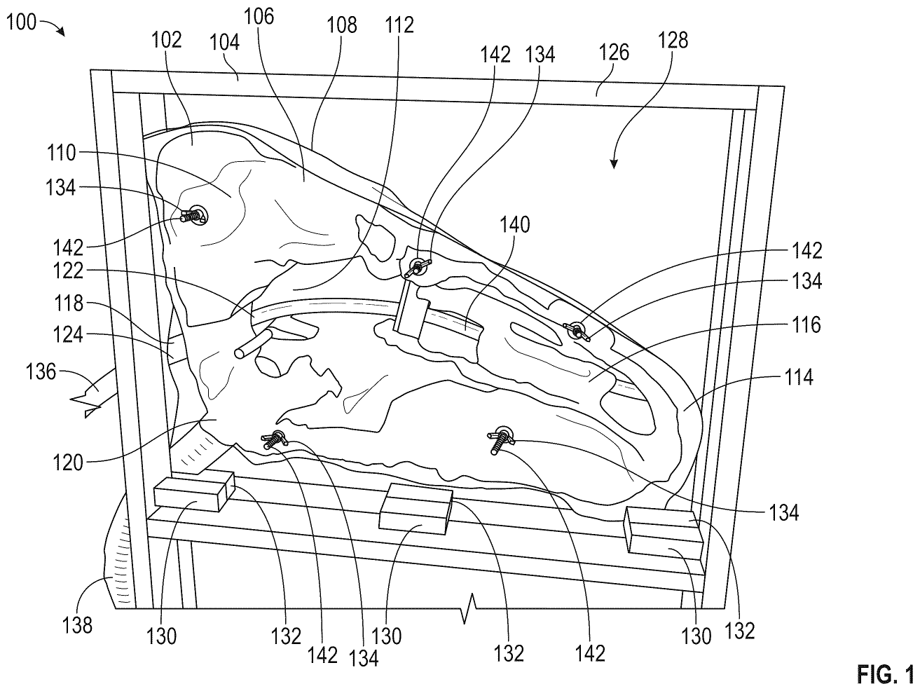

FIG. 1 illustrates a training system 100, in accordance with the disclosed embodiments. The training system 100 comprises a model 102 and display assembly 104. The model 102 can comprise a head portion 106 of an animal such as a horse, as well as additional sections of the animal (e.g. a neck portion, body portion, etc.). A first side 108 of the head portion 106 can comprise an anatomical model representative of the exterior of the animal's head. The first side 108, can include representations in roughly anatomically accurate proportions of eyes, cheeks, a nose, a mouth, bone structure, muscle location, and other features of the animal's head.

The second side 110 of the head portion 106 of the model 102 can provide visual and/or physical access to internal anatomy 112 of the head portion 106 of the animal. In certain embodiments, this can include a mouth and nose 114, and a nasal cavity 116 designed to mimic real equine anatomy so that a nasogastric tube must be properly aligned to go into the esophagus 118 or trachea 120. The internal anatomy can also include an epiglottis 122 with a functional anatomical structure. The trachea 120 is configured to mimic a real trachea and therefore provide feedback similar to the real sensation of inserting a tube in the upper airways of an animal. Likewise, the esophagus 118 can comprise a rubber band mechanism 124 that mimics the action of the horse swallowing the nasogastric tube, offering natural resistance to the user.

Esophageal extension 136 can extend out the back of the head portion 106 of the model 102, and tracheal extension 138 can extend out the back of the head portion 106 of the model 102. In certain embodiments, the esophageal extension 136, and tracheal extension 138 can be configured to be of proper anatomical length (approximately 36 inches) and can extend into a body portion of the model 102.

The display assembly 104 can comprise a frame 126 with a transparent sheet 128 affixed to the frame 126 with supports 130. The transparent sheet 128 can be a sheet of glass, plexiglass, transparent plastic, or other such transparent material. The transparent sheet 120 can fit in a slot 132 in the supports 130.

The second side 110 of the head portion 106 of the model 102 can be butted against the transparent sheet 128. In certain embodiments, mounting holes can be formed in the model 102, and transparent sheet 128, so that bolts 142 can be inserted therethrough and bound with nuts 134. In this way, the internal anatomy 112 in the model 102 is visible.

In FIG. 1, an exemplary nasogastric tube 140 is illustrated entering through the nose 114, extending through the nasal cavity 116 and epiglottis 122 and into the esophagus 118. The internal anatomy 112 is configured to allow students to practice inserting a nasogastric tube, such as nasogastric tube 140, in an animal without risking trauma to a live animal. The display assembly allows for visible inspection of the procedure, to allow the student (or educator) to evaluate when the procedure is done correctly and when it is done incorrectly.

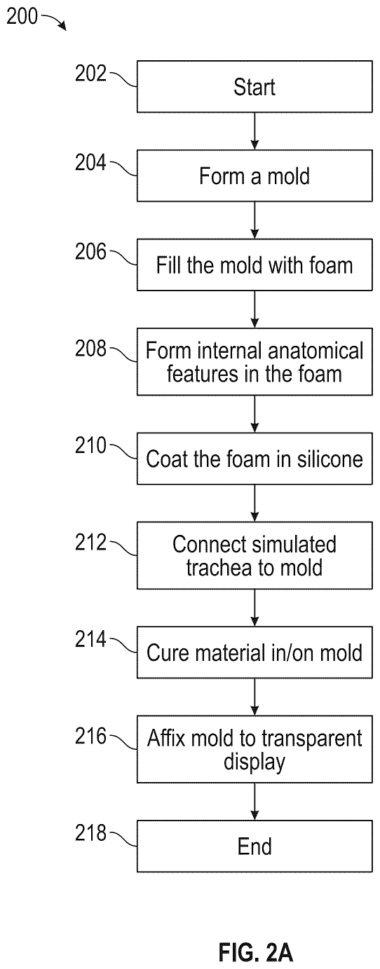

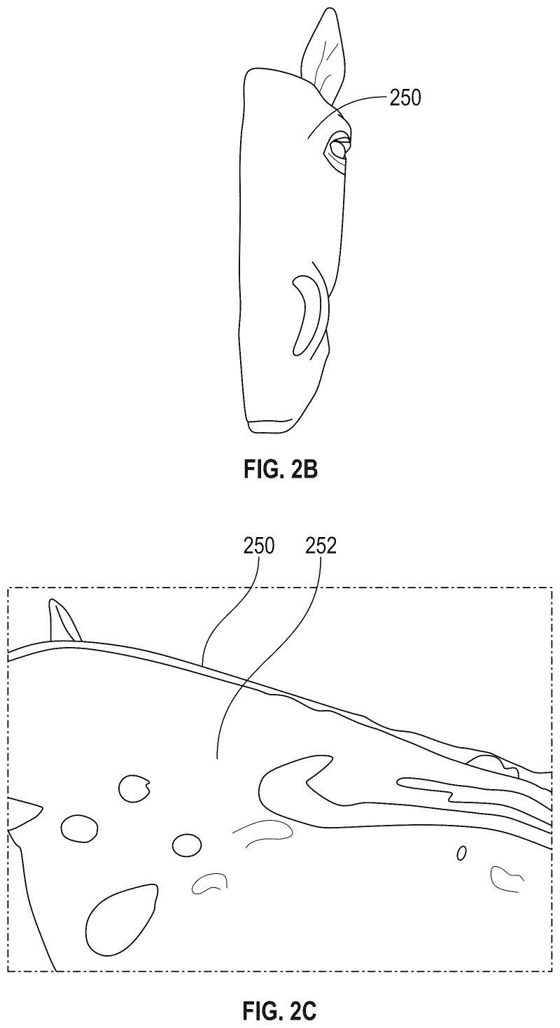

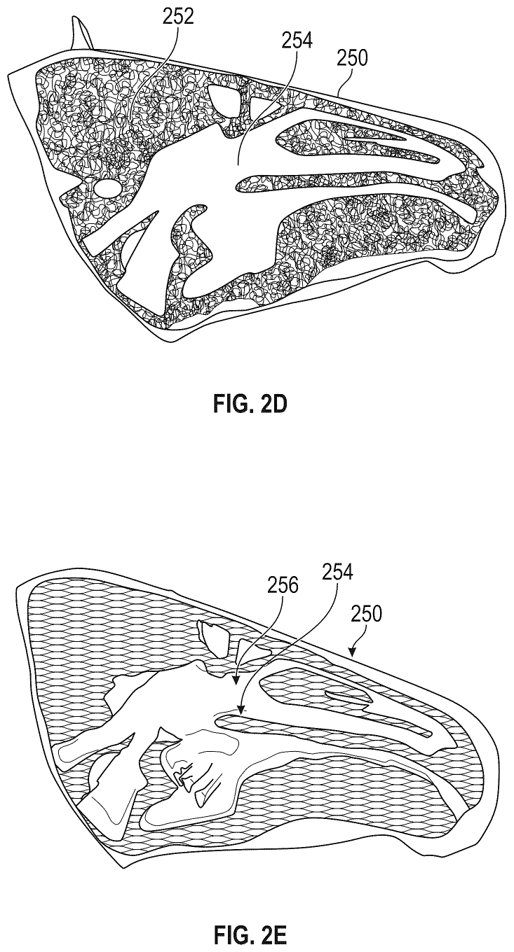

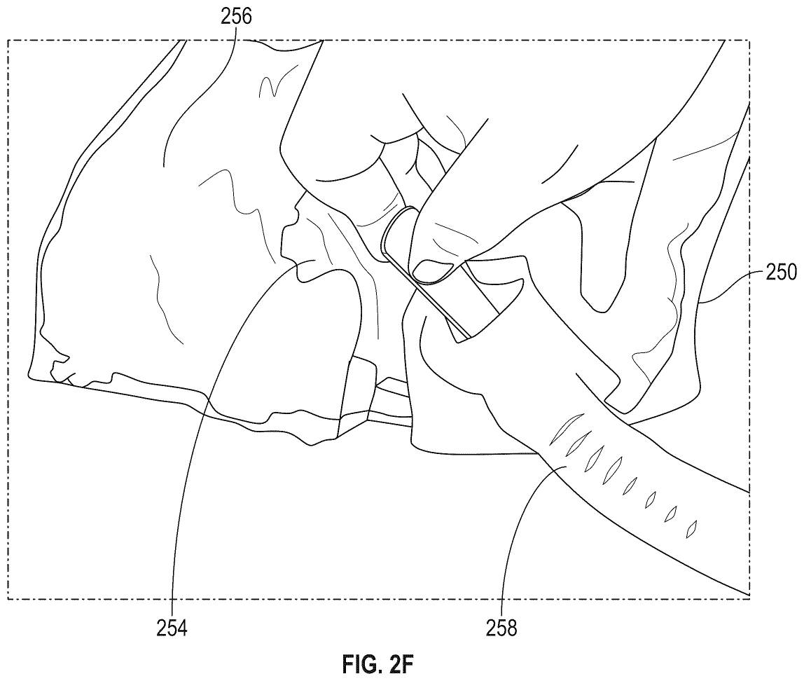

FIG. 2A illustrates steps associated with a method 200 for fabricating a training system, such as training system 100, in accordance with the disclosed embodiments. It should be appreciated that steps in method 200 can be performed in alternate orders, or simultaneously, without departing from the scope of the method. The method 200 begins at step 202.

At step 204 a mold of an animal (e.g. equine) head can be formed. In certain embodiments, the mold can comprise half of the animal's head. In an exemplary embodiment, the mold can be made of silicone, or other such material, and can be configured to be a “shell” meaning the mold only reflects the external anatomical features of the head.

FIG. 2B provides a view of an exemplary mold 250, in accordance with the disclosed embodiments. It should be appreciated that, in some embodiments, the mold 250 can be more than 50% of the width of an animal's head, such that internal anatomical features can later be formed therein.

At step 206, the empty shell of the mold can be filled with a foam, such as polyurethan foam. The foam can be shaved, so that the externally visible side of the mold is substantially flat. This facilitates mounting to a transparent sheet associated with a display assembly in later steps. FIG. 2C provides a view of an exemplary mold 250 filled with foam 252 in accordance with the disclosed embodiments.

Next at step 208, internal anatomical features of the head, including but not limited to, a mouth and nose 114, a nasal cavity 116, epiglottis, esophagus 118, and/or trachea 120 can be formed in the foam. The size and shape of the internal anatomical features can accurately represent true anatomical structures in a live animal. FIG. 2D illustrates an exemplary mold 250 filled with foam 252 and anatomical features 254 formed therein.

Once the correctly shaped and sized anatomical features are formed in the mold, at step 210 one or more coats of elastic material, such as silicone, can be applied over the foam in the mold. The material can be selected to mirror the stiffness, and texture of anatomical aspects of a living animal. FIG. 2E illustrates an exemplary mold 250 with the foam covered in silicone 256, in accordance with the disclosed embodiments.

At step 212 a simulated trachea with anatomical rings can be connected to the mold in the anatomically correct location. The simulated trachea can be covered with an elastic material such as silicone. FIG. 2F illustrates an exemplary mold 250 with a simulated trachea 258, in accordance with the disclosed embodiments. In certain embodiments, a simulated esophagus can also be connected to the mold.

At step 214 the mold is allowed to cure. Once the silicone has set and hardened, the mold can be affixed to a display system at step 216. The display system can include a transparent sheet which can be affixed to the mold, allowing visualization of the internal anatomy of the head of the animal. The method ends at 218.

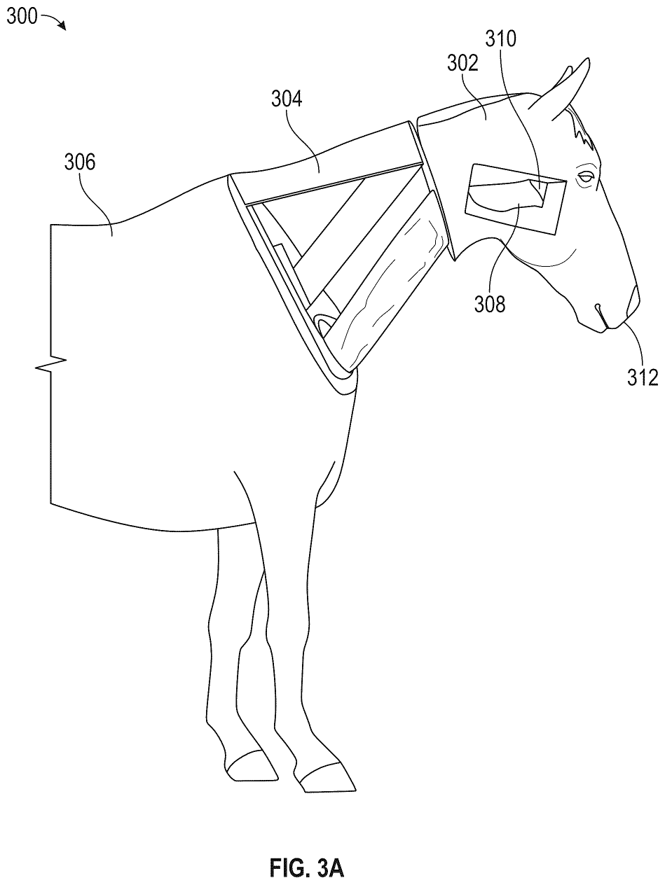

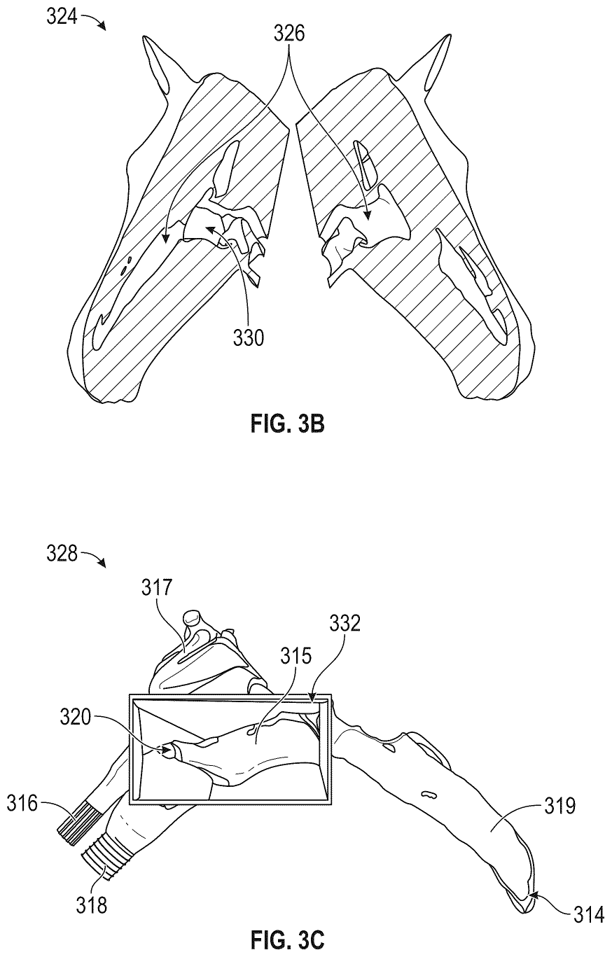

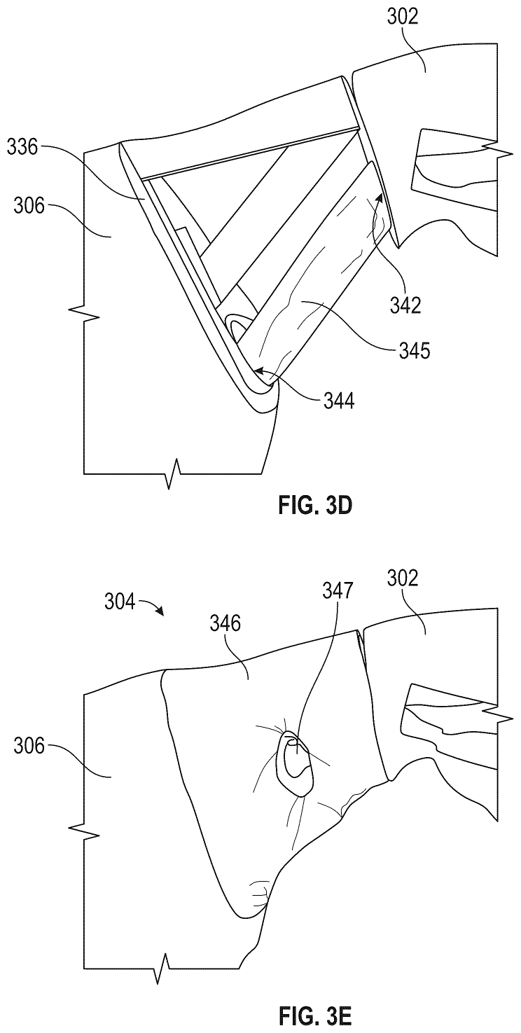

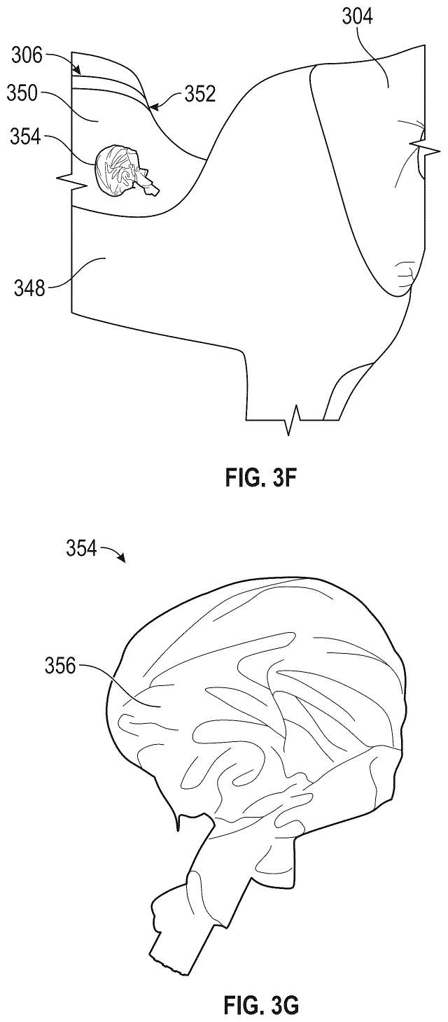

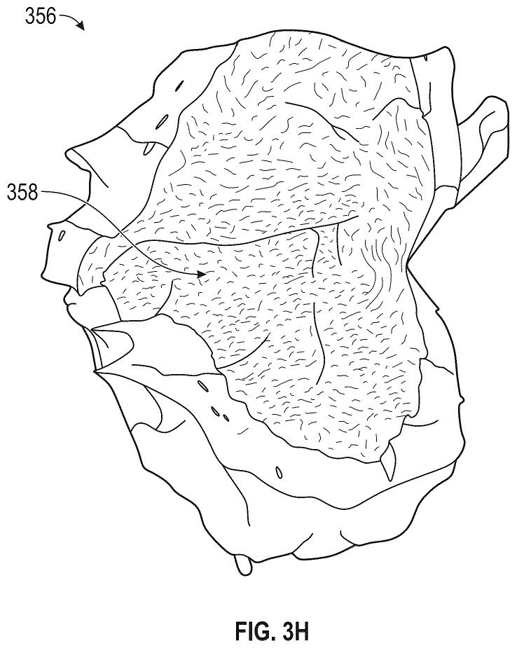

FIG. 3A illustrates aspects of a training model system 300, in accordance with the disclosed embodiments. The training model system 300 can generally comprise at least one of a head model 302, a neck model 304, and a body model 306.

FIG. 3B-3C illustrate aspects of the head model 302. The head model 302 can generally comprise a properly scaled, and anatomically accurate, three dimensional model of an animal head (e.g. a horse head). The head model 302 can include a cutout 308 providing visual and/or physical access to model internal anatomy 310. The head model 302 can accurately represent external aspects of the animal's anatomy as well, including but not limited to the mouth, nose, eyes, ears, bone structure, muscle structure, etc.

The head model 302 is configured to include anatomically accurate model internal anatomy 310. In certain embodiments, the internal anatomy 310 can include a mouth and nose 312, nare 314, and a nasal cavity 319, as depicted in FIG. 3C, designed to simulate the feel of real anatomy when a nasogastric tube is inserted into the esophagus 316 or trachea 318. The internal anatomy can also include an epiglottis 320 with a functional anatomical structure. The trachea 318 is configured to mimic a real trachea and therefore provide feedback similar to the real sensation of inserting a tube in the upper airways of an animal.

FIG. 3B illustrates a view of a model base structure 324. The model base structure 324 can comprise a plastic or rubber form in the shape of an animal head. The model base structure 324 can be manufactured in two pieces (as further detailed herein), each of which can be approximately half of the full animal head, divided down the center. The model base structure 324 can further include anatomical cutout fittings 326, configured to accept and house model anatomical features. One half of the model base structure 324 can further include a view port 330.

It should be appreciated that, in some embodiments, the model base structure 324 can comprise a shell, such that the model base structure is hallow, with an exterior profile in the shape of an animal head. The internal hollow portion of the shell can be configured to accept and house anatomical features. The model base structure 324 can alternatively include a cast silicone structure with internal channels representative of internal anatomical features as further detailed herein.

FIG. 3C illustrates an exemplary model anatomical feature 328 comprising a nare or nostril 314, nasopharynx 315, esophagus 316, trachea 318 and guttural pouch 317, and nasal cavity 319, and/or epiglottis 320. The model anatomical feature 328 can be configured to fit in the anatomical cutout fittings 326 in the model base structure 324, or can comprise channels formed in the cast silicone structure. The model anatomical feature 328 can also include a view port box 332. The view port box 332 is configured to align with the view port 330 in the model base structure 324, in order to provide physical and/or visual access to aspects within the model anatomical feature such as the nare or nostril 314, nasopharynx 315, esophagus 316, trachea 318 and guttural pouch 317, and nasal cavity 319, and/or epiglottis 320.

FIGS. 3D-3E illustrate aspects of the neck model 304. As shown in FIG. 3D, the neck model 304 can generally comprise a head-side mounting plate 334, and a body-side mounting plate 336 connected via angled support strut 338, which can comprise a strap (e.g. a welded metal strap) or other such support, and dorsal support strut 340, which can also comprise a strap (e.g. a welded metal strap) or other such support.

The head-side mounting plate 334 can include an opening 342 allowing the esophagus 316, and trachea 318 to extend out of the head model 302, through the neck model 304, and into the body model 306, through an opening 344 in the body-side mounting plate 336. The esophagus 316 and trachea 318 can be covered by a neck sheath 345 in the neck model 304.

As shown in FIG. 3E, a cover 346 can be configured around the neck portion of the neck model 304. The cover can comprise a spandex material (or other such fabric material), which can be configured to fold over the mounting plates on both ends of the neck. The dorsal support strut 338 covered by the cover 346 resembles the dorsal portion of the neck of a live animal. The cover 346 can include a pocket 347 on the side to allow access to the components inside. This allows an instructor to reach in the neck model 304 and squeeze the esophagus, to simulate the animal swallowing as a student is practicing a procedure. It can also help create an airtight seal around a nasogastric tube to allow a student to blow and feel resistance to the airflow. It should be appreciated that the trachea 318 can be configured to be palpable at the ventral side of the neck model 304, allowing the learner to shake the windpipe during simulated nasogastric tube placement, to ensure the tube is not inside the trachea (which is part of the procedure).

FIGS. 3F-3H illustrate aspects of the body model 306, in accordance with the disclosed embodiments. FIG. 3F shows the body model 306. The body model 306 can generally include a body shell 348. The body shell 348 can be approximately the size of a real animal (such as a horse). The body shell 348 can include a body cavity 350 and associated body cutout 352 providing visual and physical access to the body cavity 350.

One or more anatomical body feature 354 can be placed in the body cavity 350. For example, FIG. 3G illustrates an exemplary simulated animal stomach 356. FIG. 3H shows an opening 358 of a simulated animal stomach 356. The simulated animal stomach 356 can be connected to the esophagus 316 extending from the head model 302, through the neck model 304, into the body cavity 350 of the body model 306. The simulated animal stomach 356 can be sealed after it is connected to the esophagus 316 so that it can be filled and emptied to simulate conditions experienced by a live animal.

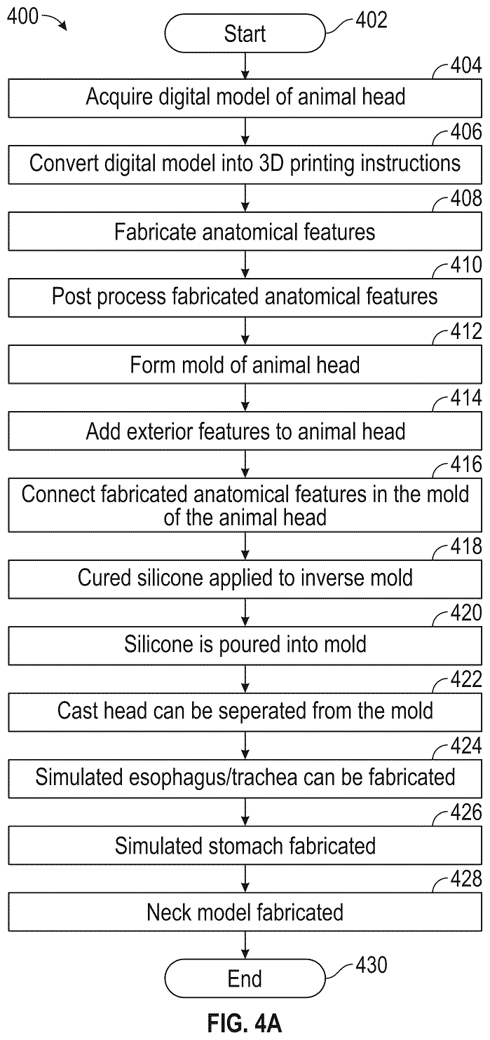

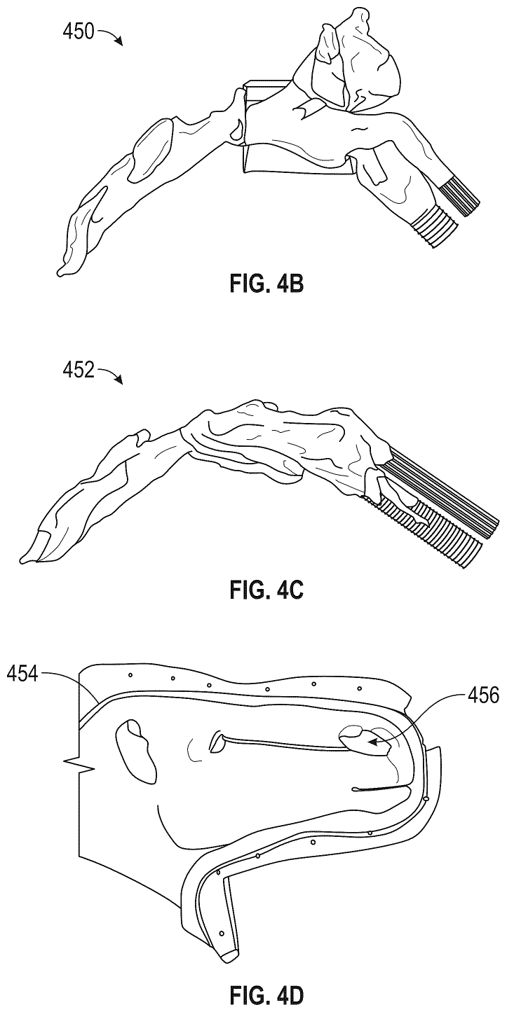

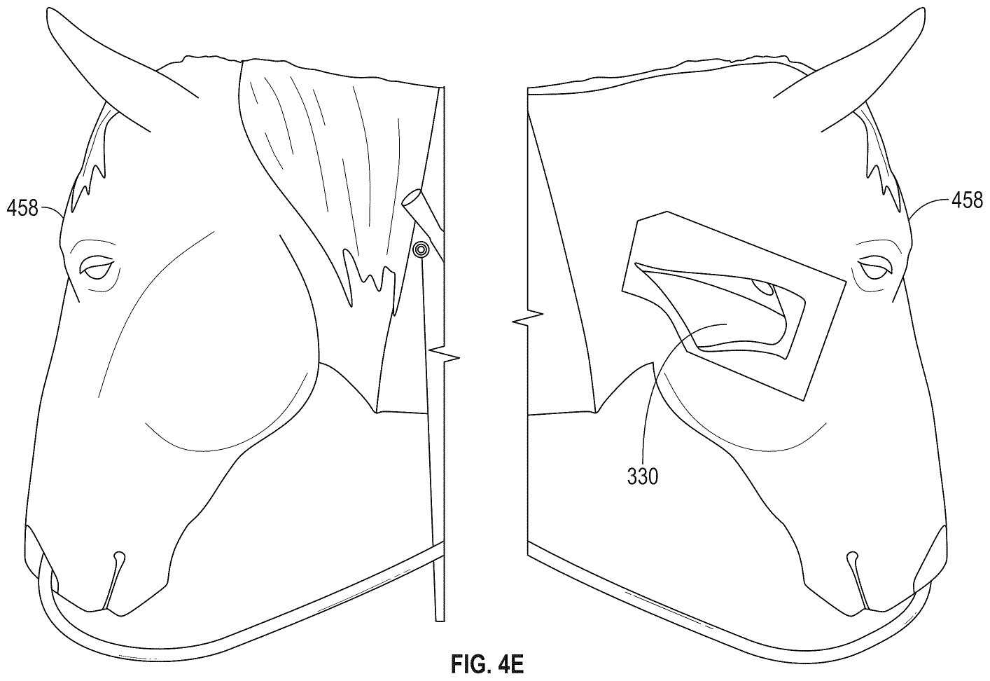

FIG. 4A illustrates steps associated with a method 400 for fabricating a training model system, such as training model system 300. It should be appreciated that steps in method 400 can be performed in alternate orders, or simultaneously, without departing from the scope of the method. The method 400 starts at 402.

The first series of steps involves generating one or more model anatomical features inside the animal's head. At step 404 a digital model of an animal's head, such as a horse's head, can be acquired. In some embodiments, this can comprise taking a CT scan of an animal's (e.g., a horse's) head that offers sufficient digital fidelity to show anatomical features in the animal's head. In other embodiments, other such digital representations of an animal's head, and associated anatomical features, can be acquired in other ways.

The airway can be isolated and identified in three dimensional object files. The three dimensional object files can include one or more of a nare, nasopharynx, viewing window to nasopharynx, laryngopharynx, oropharynx, esophagus, trachea, guttural pouch, and the like. These object files can be used to create digital models of an inverse-mold. The inverse mold can include a view port box, which is not a part of a horse's anatomy, but is included to facilitate physical and/or visual access to the anatomical features in the completed training model system. The digital files can comprise STL files, or other such three dimensional software modeling files.

At step 406, the digital files can be converted into instructional files for 3D printing equipment. In some embodiments, these files can be G-code, or other such files for 3D printer instructions. A 3D printer can then be used to create inverse molds of the anatomical features at step 408. FIG. 4B illustrates exemplary inverse molds 450. It should be appreciated that, in other embodiments, other fabrication methods can also be used for the anatomical features. In certain embodiments, the molds can be a tough PLA plastic, or other such material capable of being printed with a 3D printer.

At step 410 the printed anatomical features are subject to post processing. This can include the printed anatomical features being removed from supporting structures, cleaned, and if they were printed independently, adhered together using epoxy, or other such adhesive. The printed anatomical features can also be coated with a post processing applique (e.g. XTC-3D) specifically configured to smooth ridges created from 3D printing. FIG. 4C illustrates a post processed inverse mold 452, in accordance with the disclosed embodiments.

At step 412 a mold of an animal head can be formed. In certain embodiments, the mold can comprise a 3-part fiberglass mold and can comprise a head and a portion of the neck; for example, approximately 6 inches below the horse's throat latch. The mold is configured to split medially to create two lateral halves of the head. An exemplary half of the mold 454 is illustrated in FIG. 4D.

The mold can include a view port or window cut into the side. The window is configured to accept the view port box associated with the inverse model of the anatomical features to provide visual and/or physical access to the anatomical features such as the nasopharynx therein. The mold can include a hole 456, which is drilled in the medial corner of the left eye to allow a tube to pass, representing the lacrimal canal.

At step 414, the mold is used in a roll cast method, to create the exterior skin, eyes, nose and ears for each lateral side of the mold using black platinum cure silicone. A spacer can be inserted at the nose to create a cavity that allows the animal to be twitched during a nasogastric tube placement or endoscopy procedure.

In certain embodiments, one or more support struts or straps can be articulated within the head to add support, as well as articulation in the region of the C1 vertebrae. The articulation helps mimic the movements associated with nasogastric tube placement or endoscopy.

At step 416, the inverse mold of the nare, nasopharynx, viewing window, laryngopharynx, oropharynx, esophagus, trachea and guttural pouch are positioned and placed in the head mold. One or more of these component can be secured in place in the head mold to prevent unnatural movement. A silicone tube can be placed at the nare, and extended medially to the left eye on the opposite side of the head mold. This creates the lacrimal canal.

Next at step 418, a thickened platinum cured silicone can be applied to the inverse mold, spacer, and silicone tube. Additional layers of flesh toned platinum cured silicone can also be applied to create the cavity for the airway, guttural pouch and esophagus.

Once everything is coated thoroughly at step 418, a filling material, such as silicone, can be poured into the head mold until it is filled at step 420. This may require careful positioning of the head mold. The filling material can be cured, or otherwise allowed to harden. At step 422, the casting of the head can then be removed from the mold, cut medially along the ventral side to remove the spacer and the inverse molds and then rejoined. The seam can be treated with sil-poxy or platinum silicone. At this point the head model, such as head model 302 is complete. FIG. 4E illustrates provides side views of the cast head model 458. In this view the view port 460 in the head model 458 is visible.

At step 424 the simulated esophagus and trachea can be fabricated and connected to a simulated stomach. In certain embodiments, 3D printed columns can be used as a base and thickened silicone can be coated over the structures until a ¼-½″ thick wall is formed. The trachea can be ribbed, and esophagus can be striated to add realism. The columns are removed once a length of 36″ is obtained. The trachea can be bifurcated to show bronchial branches. The esophagus can then be attached to a simulated stomach, while the other ends are mended to the appropriate corresponding points on the horse head.

At step 426 the simulated stomach can be fabricated. In certain embodiments, a plastinated stomach of an actual horse can be filled with platinum silicone to create an inverse mold. Once removed, the inverse mold of the stomach can be painted with silc-pig to match the coloration of the equine stomach and then coated with silicone to reach a ½″ to 1″ thick wall. The wall can be cut after being cured to remove the inverse mold and then mended with Sil-poxy. A flap can be created to simulate the cardiac opening of the stomach. Once the simulated stomach is complete, it can be attached (as described above at step 424) to the esophagus with an attachment to allow the stomach to be filled and emptied.

In certain embodiments, where a full scale horse model is desired additional steps can be included. At step 428 the neck can be fabricated and connected to the model head and model body. Straps (e.g. metal straps) can be affixed to mounting plates and shaped to the outer lines of the caudle side of the cast head. A hole can be cut in the mounting plate to allow the esophagus and trachea to pass through.

Another mounting plate can be cut to fit the edges of cranial face or flat area where the neck attaches to the model body. Holes are cut to allow fastening to mounting points in the model body. A hole in the mounting plate is also created to allow the trachea and esophagus to pass through into the model body. A strap between the two plates is used to simulate the neckline of the animal. Supports can be placed in the model body to hold and support the stomach inside the body cavity.

A cover comprising a spandex-type material can be used to enclose the neck, and fold over the respective mounting plates on both ends of the neck model. The dorsal strap creates the dorsal portion of the neck, and the trachea extends on the ventral side. A pocket can be formed on the cover (e.g., on the right side of the neck model) to allow an instructor or student to reach in to squeeze the esophagus to simulate a horse swallowing. The method ends at step 430.

Based on the foregoing, it can be appreciated that a number of embodiments, preferred and alternative, are disclosed herein. For example, in an embodiment, a method for fabricating a training model comprises fabricating at least one inverse anatomical feature representative of an anatomical feature in an animal's head, forming a mold of the animal's head, connecting the at least one inverse anatomical feature in the mold of the animal's head, filling the mold of the animal's head with a filling material, and removing the cast head from the mold. In an embodiment, the method for fabricating a training model further comprises acquiring a digital model of the animal's head. In an embodiment, fabricating the inverse anatomical features representative of anatomical features in an animal's head further comprises 3D printing the inverse anatomical features. In an embodiment, the method for fabricating a training model further comprises coating the inverse anatomical features with an applique to smooth the inverse anatomical features. In an embodiment, the anatomical feature comprises at least one of: a nare, laryngopharynx, an oropharynx, a nasopharynx, an esophagus, a trachea, and a guttural pouch. In an embodiment, the method for fabricating a training model further comprises fabricating a viewing window to the nasopharynx. In an embodiment, the method for fabricating a training model further comprises adhering the at least one anatomical features to one another. In an embodiment, the filling material comprises silicone. In an embodiment, the method for fabricating a training model further comprises curing the silicone. In an embodiment, the animal's head comprises a horse's head.

In an embodiment, a method for fabricating a training system comprises fabricating a mold comprising a shell of an animal's head, inserting foam in the mold, forming at least one anatomical feature in the foam, applying at least one coat of material over the foam, and affixing the mold to a display system. In an embodiment, forming the at least one anatomical feature in the foam comprises cutting away foam in anatomically accurate shapes. In an embodiment, the coat of material comprises silicone. In an embodiment, the method for fabricating a training model further comprises curing the silicone. In an embodiment, the at least one anatomical feature comprises at least one of a mouth and nose, a nasal cavity, an epiglottis, an esophagus, and a trachea. In an embodiment, the display system comprises a transparent sheet. In an embodiment, the animal's head comprises a horse's head.

In an embodiment, a head model comprises a cast silicone structure in a shape of an animal's head, at least one anatomical feature formed in the case silicone structure, and at least one view port configured to provide visual and/or physical access to the at least one anatomical feature formed in the base silicone structure. In an embodiment, the at least one anatomical feature comprises at least one of a nare, a nostril, a laryngopharynx, an oropharynx, a nasopharynx, an esophagus, a trachea, a guttural pouch, a nasal cavity, and/or an epiglottis. In an embodiment, the animal's head comprises a horse's head.

It will be appreciated that variations of the above-disclosed and other features and functions, or alternatives thereof, may be desirably combined into many other different systems or applications. Also, it should be appreciated that various presently unforeseen or unanticipated alternatives, modifications, variations, or improvements therein may be subsequently made by those skilled in the art which are also intended to be encompassed by the following claims.

What is claimed is:

1. A method for fabricating a training model comprising:
fabricating at least one inverse anatomical feature representative of an anatomical feature in an animal's head;
forming a mold of the animal's head;
connecting the at least one inverse anatomical feature in the mold of the animal's head;
filling the mold of the animal's head with a filling material, thereby forming a cast head; and
removing the cast head from the mold.

2. The method for fabricating a training model of claim 1 further comprising:
acquiring a digital model of the animal's head.

3. The method for fabricating a training model of claim 1 wherein fabricating inverse anatomical features representative of anatomical features in an animal's head further comprises:
3D printing the inverse anatomical features.

4. The method for fabricating a training model of claim 3 further comprising:
coating the inverse anatomical features with an applique to smooth the inverse anatomical features.

5. The method for fabricating a training model of claim 1 wherein the at least one inverse anatomical feature comprises at least one of:
a nare;
a nasopharynx;
a laryngopharynx;
an oropharynx;
an esophagus;
a trachea; and
a guttural pouch.

6. The method for fabricating a training model of claim 5 further comprising:
fabricating a viewing window in the mold of the animal's head.

7. The method for fabricating a training model of claim 5 further comprising adhering the at least one anatomical features to one another.

8. The method for fabricating a training model of claim 1 wherein the filling material comprises silicone.

9. The method for fabricating a training model of claim 8 further comprising:
curing the silicone.

10. The method for fabricating a training model of claim 1 wherein the animal's head comprises a horse's head.

11. A method for fabricating a training system comprising:
fabricating a mold comprising a shell of an animal's head;
inserting foam in the mold;
forming at least one anatomical feature in the foam;
applying at least one coat of material over the foam; and
affixing the mold to a display system.

12. The method for fabricating a training system of claim 11 wherein forming the at least one anatomical feature in the foam comprises:
cutting away foam in anatomically accurate shapes.

13. The method for fabricating a training system of claim 11 wherein the coat of material comprises silicone.

14. The method for fabricating a training system of claim 13 further comprises:
curing the silicone.

15. The method for fabricating a training system of claim 11 wherein the at least one anatomical feature comprises at least one of:
a mouth;
a nose;
a nasal cavity;
a laryngopharynx;
an oropharynx;
an epiglottis;
an esophagus; and
a trachea.

16. The method for fabricating a training system of claim 11 wherein the display system comprises:
a transparent sheet.

17. The method for fabricating a training system of claim 11 wherein the animal's head comprises a horse's head.

18. A head model comprising:
a cast silicone structure in a shape of an animal's head;
at least one anatomical feature formed in the case silicone structure; and
at least one view port configured to provide visual and/or physical access to the at least one anatomical feature formed in the base silicone structure.

19. The head model of claim 18 wherein the at least one anatomical feature comprises at least one of:
a nare;
a nostril;
a nasopharynx;
a laryngopharynx;
an oropharynx;
an esophagus;
a trachea;
a guttural pouch;
a nasal cavity; and
an epiglottis.

20. The head model of claim 18 wherein the animal's head comprises a horse's head.
